(19) United States
(12) Patent Application Publication
(10) Pub. No.: US 2015/0085159 A1
(43) Pub. Date: Mar. 26, 2015

(54) MULTIPLE IMAGE CAPTURE AND PROCESSING

(71) Applicant: NVIDIA Corporation, Santa Clara, CA (US)

(72) Inventors: Abhinav Sinha, Sunnyvale, CA (US); Yining Deng, Fremont, CA (US)

(73) Assignee: NVIDIA Corporation, Santa Clara, CA (US)

(21) Appl. No.: 14/032,569

(22) Filed: Sep. 20, 2013

(51) Int. Cl. H04N 5/77; H04N 5/232; H04N 5/235; H04N 1/21; H04N 9/73

(52) U.S. Cl. CPC H04N 5/772; H04N 1/2112; H04N 9/73; H04N 5/2353; H04N 5/23212; H04N 2201/0084
USPC 348/231.6

(57) ABSTRACT

Various embodiments relating to image capture with a camera and generation of a processed image having desired image characteristics are provided. In one embodiment, a plurality of images of a scene captured by a camera and associated image metadata are stored. Image metadata associated with each image of the plurality of images includes image characteristics of that image, and each image has a different set of values of image characteristics. A request for an image of the scene that most closely matches a specified image characteristic profile that defines one or more values of one or more image characteristics is received. The image characteristic profile is compared to image metadata of each of the plurality of images. A processed image generated from the plurality of images of the scene having image characteristics that most closely match the image characteristic profile based on the comparison is provided.

### BACKGROUND

Typically, an image is captured with fixed image characteristics (e.g., exposure, focus, white balance, etc.). In one example, the image characteristics of a captured image are manipulated via software post processing (e.g., adjusting digital gains) to generate an image with desired image characteristics. However, such an approach produces an image that has a much lower signal-to-noise ratio than the originally captured image, which results in a reduction of image quality.

### BRIEF DESCRIPTION OF THE DRAWINGS

FIG. 1 schematically shows a camera system according to an embodiment of the present description.

FIG. 2 shows a method for controlling a camera based image characteristic feedback according to an embodiment of the present description.

FIG. 3 shows a method for providing feedback to a camera for controlling camera settings to capture a plurality of images of a scene according to an embodiment of the present description.

FIG. 4 shows a method for selecting an image of a scene captured by a camera based on a desired image characteristic profile according to an embodiment of the present description.

FIG. 5 shows a method 500 for providing a high dynamic range image from a plurality of images of a scene captured by a camera according to an embodiment of the present description.

FIG. 6 shows a graphical user interface (GUI) 600 according to an embodiment of the present description.

### DETAILED DESCRIPTION

The present description relates to an approach for generating an image of a scene having desired image characteristics from a plurality of captured images of the scene having different sets of image characteristic values. More particularly, the present description relates to capturing a plurality of images of a scene with a large number of different image characteristic values (e.g., varying image characteristics across all of the images from a set low value to a set high value according to defined granular steps), and generating an image having image characteristics that most closely match a desired image characteristic profile from the plurality of captured images of the scene. The image characteristic profile may define values of one or more image characteristics. In one example, an image is generated by simply selecting an image having image characteristic values that most closely match the image characteristic profile from the plurality of images. In another example, an image is generated by compositing a new image using pixels from different images of the plurality of images having image characteristic values that match the image characteristic profile. For example, such an approach may be used to generate a high dynamic range (HDR) image. By generating an image having image characteristic values that most closely match the image characteristic profile, post processing of the selected image may be reduced or eliminated to provide an image that has a higher signal-to-noise ratio relative to an image that undergoes software post processing to achieve the desired image characteristics.

Furthermore, prior to capturing the plurality of images of the scene, feedback in the form of a suggested range of values of image characteristics may be provided. For example, the range of values of the image characteristics may be based on preferences of a source. Camera settings may be adjusted to capture the plurality of images, such that each image has a different set of values within the suggested range of values of the image characteristics (e.g., defined granular steps across the range). In this way, a smaller number of images may be captured that may potentially meet the criteria of the image characteristic profile. Accordingly, a duration to capture the plurality of images and storage resources may be reduced.

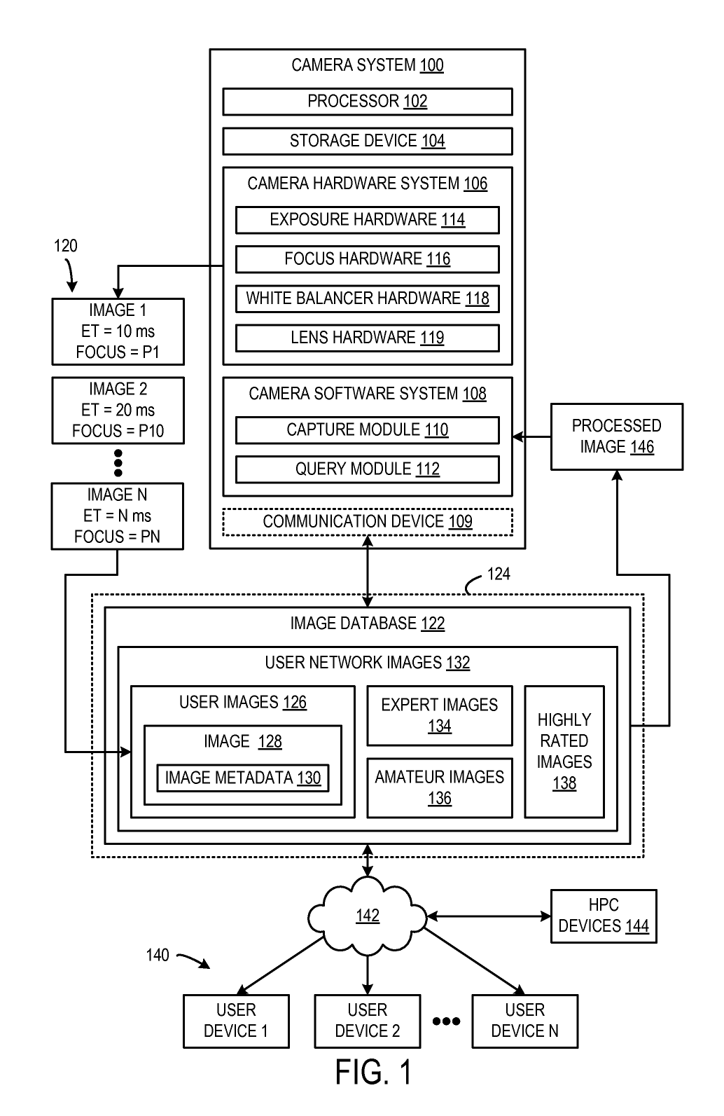

FIG. 1 schematically shows a camera system 100. The camera system 100 may take the form of any suitable device including a computer, such as mobile computing devices (e.g., tablet), mobile communication devices (e.g., smart phone), and/or other computing devices. The camera system includes a processor 102, a storage device 104, a camera hardware system 106, and a camera software system 108.

The processor 102 includes one or more processor cores, and instructions executed thereon may be configured for sequential, parallel, and/or distributed processing. The processor includes one or more physical devices configured to execute instructions. For example, the processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

In one example, the processor includes a central processing unit (CPU) and a graphics processing unit (GPU) that includes a plurality of cores. In this example, computation-intensive portions of instructions are executed in parallel by the plurality of cores of the GPU, while the remainder of the instructions is executed by the CPU. It will be understood that the processor may take any suitable form without departing from the scope of the present description.

The storage device 104 includes one or more physical devices configured to hold instructions executable by the processor. When such instructions are implemented, the state of the storage device may be transformed—e.g., to hold different data. The storage device may include removable and/or built-in devices. The storage device may include optical memory, semiconductor memory, and/or magnetic memory, among others. The storage device may include volatile, nonvolatile, dynamic, static, read/write, read-only, random-access, sequential-access, location-addressable, file-addressable, and/or content-addressable devices. It will be understood that the storage device may take any suitable form without departing from the scope of the present description.

The camera hardware system 106 is configured to capture an image. The camera hardware system includes different hardware blocks that adjust various settings to define values of image characteristics of a captured image. In the illustrated example, the camera hardware system includes exposure hardware 114, focus hardware 116, white balance hardware 118, and lens hardware 119.

The exposure hardware is configured to adjust camera hardware settings that modify a value of an exposure image characteristic. For example, the exposure hardware may be configured to adjust an aperture position of a camera lens (although in some embodiments the aperture may be fixed), an integration/shutter timing that defines an amount of time that light hits an image sensor, an image sensor gain (e.g., ISO speed) that amplifies a light signal, and/or another suitable setting that adjusts an exposure value (e.g., exposure time).

The focus hardware is configured to adjust camera hardware settings that modify a value of a focus image characteristic. For example, the focus hardware may be configured to adjust a lens position to change a focus value (e.g., a focus point/plane). In one example, the focus hardware moves a plurality of lens elements collectively as a group towards or away from an image sensor of the camera hardware system to adjust the focus value.

The white balance hardware is configured to adjust camera hardware settings that modify a value of a white balance image characteristic. For example, the white balance hardware may be configured to adjust relative levels of red and blue colors in an image to achieve proper color balance. Such operations are performed prior to the image signal being digitized as it comes off of the image sensor.

The lens hardware is configured to adjust camera hardware settings that modify a value of a lens image characteristic. For example, the lens hardware may be configured to adjust a zoom level or value. In one example, the lens hardware moves one or more lens elements relative to other lens elements, with spacing between lens elements increasing or decreasing to change a light path light through the lens that changes the zoom level.

It will be understood that the camera hardware system may include additional hardware blocks that perform additional image capture operations and/or adjust settings to change values of image characteristics of a captured image other than the image characteristics discussed above.

Continuing with FIG. 1, storage locations of the storage device include a memory allocation accessible by the processor during execution of instructions. This memory allocation can be used for execution of a camera software system 108 that includes a capture module 110 and a query module 112. The capture module adjusts settings of the camera hardware system to capture a plurality of images of a scene responsive to a capture request. The query module queries an image database prior to capturing a plurality of images of scene for feedback indicating how to adjust settings of the camera hardware system to capture the scene. The query module further queries the image database after the plurality of images are stored in the image database to select an image from the plurality of images that most closely matches an image characteristic profile.

The capture module 110 is configured to receive a request to capture a static scene at which the camera system is aimed. For example, the request may be made responsive to user input, such as a user depressing a capture button on the camera system. When a capture is requested, the capture module controls the camera hardware system to capture a plurality of images 120 of the scene with a large number of different image characteristic values. In other words, a single capture request initiates capture of a plurality of images of the scene having different image characteristic values.

In one example, the image characteristics include an exposure setting, a focus setting, a white balance setting, and a zoom setting, and the plurality of images include image characteristics that vary by a defined granular step across a range of values of each of the exposure setting, the focus setting, and the white balance setting. To capture images that have all possible combinations of values across the different ranges of values of the image characteristics, the capture module controls the different image characteristic blocks of the camera hardware system to change the different image characteristic values for capture of each image across all of the ranges. For example, each image characteristic setting may have a value range of 10 and a defined granular step of 1. For the purposes of this example, the image characteristic values are represented as (exposure value, focus value, white balance value, zoom value). So, the camera hardware may start by capturing an image having values at the bottom of each range (e.g., (1, 1, 1, 1)), and may continue to capture images with values that step through each of the ranges (e.g., (2, 1, 1, 1)-(10, 10, 10, 9)). The camera hardware may finish by capturing an image having values at the top of each range (e.g., (10, 10, 10, 10)). In this example, the camera hardware captures 5040 images of the scene to cover all permutations of the different image characteristic values. In other words, when the camera system finishes a single capture request a plurality of images with all possible combinations of image characteristics over a specified range of values is captured. In the illustrated example, the images have an exposure time range of 1-N (ms) with a granular step of 10 (ms) and a focus point range of P1-N with a granular step of 10 focus points, where N is any desired value that defines the top end of the range.

It will be appreciated that the plurality of captured images may cover virtually any suitable range of image characteristic values and may include virtually any suitable number of different image characteristics. Further, it will be appreciated that virtually any suitable granularity of steps may be taken between values of images, and different size steps may be taken in different portions of the range. For example, in a low end portion of a range a step size may be 1 and in a high end portion of the range the step size may be 3. Moreover, it will be appreciated that different image characteristics may have different size value ranges and steps.

Captured images are stored in an image database 122. In some embodiments, the image database is situated locally in the camera system. For example, the image database may be stored in the storage device of the camera system. In some embodiments, the image database 122 is situated in a remote computing device 124 that is accessible by the camera system. In some embodiments, the camera system includes a communication device 109 that enables communication with the remote computing device. In one example, the communication device is a network device that enables communication over a network, such as the Internet. In other words, the camera system may capture the plurality of images and send or stream the captured images to the remote computing device via the network for permanent storage.

The images captured from the camera system may be stored as user images 126. In particular, each image 128 is stored with associated image metadata 130. The image metadata may indicate image characteristics of that image, statistics, and scene content. Non-limiting examples of image metadata include a capture time, a capture location (e.g., GPS coordinates), an image histogram, tags of landmarks, people, and objects identified in the scene, a rating of the image provided by the user and/or other users of a network of users, a user that captured the image, a camera type that capture the image, and any other suitable data/information that characterizes the image. The image metadata may be used to classify the images into different categories in the database, and then may be used to intelligently generate a processed image 146 that fits a desired image characteristic profile, as well as to suggest ranges of image characteristic values to be used in the future to capture other images.

In some embodiments, images stored in the database are aggregated from a network of users and are referred to as user network images 132. For example, the user network may include a social network, a photography community, or another organization. Various user network images may be aggregated from a plurality of user devices 140 in communication with the image database via a communication network 142, such as the Internet. Note that the communication device of the camera system may communicate with the remote computing device using the communication network or through another network or another form of communication. Non-limiting examples of user devices that may provide images to the image database include cameras, mobile computing device (e.g., a tablet), communication computing device (e.g., a smartphone), laptop computing device, desktop computing devices etc. In some embodiments, each device may be associated with a different user of the user network. In some cases, multiple devices may be associated with a user.

In some embodiments, the user network may include different classifications of users. For example, the user network may include expert photographers and amateur photographers. Expert images 134 may be classified and used differently than amateur images 136, as will be discussed in further detail below. It will be appreciated that a user may be designated as an expert photographer according to virtually any suitable certification or vetting process.

As discussed above, in some embodiments, images aggregated in the image database may be used to provide feedback and/or suggestions for controlling the camera system to capture a plurality of images of a scene. More particularly, the feedback may include a suggested range of values of image characteristics that may be used to capture images of a scene. The suggested range of values may be less than a total capable range of values of the camera system. In this way, a total number of images to capture a scene may be reduced while maintaining a high likelihood of producing an image having desired image characteristics without the need for post processing that may reduce image quality.

In one example, the query module of the camera software system sends a reference image of a scene to the image database. For example, the reference image may be a single image of a scene captured initially to be used for scene analysis prior to capturing the plurality of images. Additionally or alternatively, the camera system sends image metadata associated with the reference image and representative of the scene to the image database. The image database compares the reference image and/or associated image metadata representative of the scene with the images and associated image metadata stored in the image database. The image database may identify a subset of images in the image database that match the scene based on the comparison. For example, the subset of images may be identified based on matching image metadata, such as a GPS position, tags of landmarks, or the like. Additionally or alternatively a computer vision process may be applied to the reference image to identify the scene. In one example, the image database sends the reference image to high powered computing devices 144 to perform the computer vision process (e.g., via parallel or cloud computing) or other analysis to identify the scene.

Once the subset of images that match the scene in the reference image is identified, the image database (and/or the query module) may determine a range of values of one or more image characteristics based on image metadata of one or more images of the subset. In one example, a range of values for each image characteristic is suggested based on the image metadata of the matching images. In one particular example, a different range of values are suggested for each of the exposure setting, the focus setting, and the white balance setting. In another example, the range of values of each image characteristic may be set by relative high and low values of that image characteristic in the subset. In another example, the one or more images of the subset whose image metadata on which the suggested range of values is based are selected because the one or more images are associated with an expert photographer. For example, if the subset includes an image of the scene captured by an expert photographer, then the suggested range of values may be based on the image characteristics of that image.

In some embodiments, images stored in the image database are rated by the users of the user network. For example, each image stored in the image database may have metadata indicating a rating of that image (e.g., a highly rated image may be rated 5 out of 5 stars). Highly rated image 138 may be used to provide feedback of image characteristics. In one example, the one or more images of the subset whose image metadata on which the suggested range of values is based are selected because the one or more images are rated highly by the network of users. In other words, the suggested range of values may be based on the highest rated images of the subset.

In some embodiments, environmental conditions of the scene are inferred from the image metadata of the reference image, and the suggested range of values of the image characteristics are further based on the inferred environmental conditions of the scene. In one example, the metadata includes GPS position information and a capture timestamp. The image database communicates with a weather service computing device (e.g., HPC device 144) to determine weather conditions at the scene (e.g., sunny, cloudy, rainy, etc.) and adjust the suggested range of values to accommodate the weather conditions. In another example, the capture timestamp may be used to infer daytime or nighttime conditions, and adjusted the suggested range of values to accommodate such conditions.

In some embodiments, the query module may further send camera metadata associated with the camera system that generated the reference image to the image database. The camera metadata indicates camera-specific settings for manipulating image characteristics of images generated by the camera. Further, the image database may factor in the camera metadata when providing feedback. In one example, the suggested range of values of the one or more image characteristics only include values of image characteristics capable of being achieved by the camera-specific settings. In another example, the subset of images only includes images taken by the type of camera that has the same camera-specific settings.

It will be appreciated that the suggested range of values may be derived from image characteristics of a single image of the subset. For example, the image characteristic values of the single image may be set as median values of the suggested range. It will be appreciated that the image characteristics of a single image may be used in any suitable manner to determine a range of suggested values.

In some embodiments, the suggested range of values may be determined independent of metadata of images that match a scene of a reference image. In one example, the camera system queries the image database for a suggested range of values without sending a reference image and the image database returns a suggested range of values of one or more image characteristics based on preferences of one or more sources. In one example, the sources include images previously captured by the camera system and/or an associated user. In another example, the sources include highly rated images previously captured by the camera system and/or an associated user. In another example, the sources include highly rated images captured by other users in the network of users. In another example, the sources include expert photographers. It will be appreciated that the image database may provide a suggested range of values of one or more image characteristics from any suitable source or combination of sources.

Once the camera system receives the feedback from the image database, the camera system is configured to adjust settings of the camera hardware system to capture the plurality of images of the scene. Each image has a different set of values within the suggested range of values of the one or more image characteristics. In one example, the plurality of images includes image characteristics that vary by a defined granular step across the suggested range of values of each image characteristic.

The plurality of captured images of the scene and associated metadata are stored in the image database. The plurality of captured image contributes to providing feedback for future capture requests. Moreover, the plurality of captured images can be analyzed to provide a selected image that has image characteristics that most closely matches a desired image characteristic profile. The selected image may be provided instead of performing post processing on an image that does not match an image characteristic profile. In this way, the selected image may have a higher signal-to-noise ratio than the image that does not match the image characteristic profile.

In one example, the camera system receives a request for an image of the plurality of images of the scene that most closely matches a specified image characteristic profile that defines one or more values of one or more image characteristics. In one example, the image characteristic profile includes a specified exposure setting value, a specified focus setting value, and a specified white balance setting value. The image characteristic profile may be provided in a variety of different ways. In one example, the image characteristic profile is provided via user input to a graphical user interface that enables user manipulation of different image characteristics of the image characteristic profile. In another example, the image characteristic profile is provided based on image characteristics of previously captured images rated highly by the user of the camera system. In another example, the image characteristic profile is provided based on average preferences of image characteristics of the network of users.

The query module sends the image characteristic profile to the image database to perform a comparison of the image characteristic profile to image metadata of each of the plurality of images of the scene. The image database provides the processed image generated from the plurality of images of the scene having image characteristics that most closely match the image characteristic profile based on the comparison. In one example, the processed image is selected from the subset of images. More particularly, in one example, the closest matching image that is selected has a smallest average difference of image characteristic values relative to the values of the image characteristic profile. In another example, the processed image is generated by compositing pixels or pixel regions having image characteristic values that match the image characteristic profile from different images of the subset to form the processed image.

In some embodiments, the camera system receives a specified region of interest of the scene. In one example, the region of interest is provided via user input to a graphical user interface. The query module sends the region of interest to the image database along with the image characteristic profile. The image database compares values of the image characteristic profile with values in the region of interest in the plurality of images of the scene. Further, the image database returns an image selected from the plurality of images of the scene that has image characteristics values in the region of interest that most closely matches values of the image characteristic profile. In one particular example, the image database performs focus and/or exposure analysis on the region of interest of each of the plurality of images of the scene, and returns an image having a highest focus score and/or a highest exposure score of the region of interest.

In some embodiments, the camera system generates the processed image in the form of a high dynamic range (HDR) image of the scene from images selected from the plurality of images. In one example, the camera system sends a range of values of one or more image characteristics to the image database. For example, the range of values of image characteristics may be provided via user input to a graphical user interface that enables user manipulation of different image characteristics. In one example, a range of values is provided for each of an exposure setting, a focus setting, and a white balance setting. The image database compares the range of values of each of the image characteristics to the plurality of images of the scene and provides a subset of images of the scene based on the comparison. In particular, each image of the subset of images of the scene has a value of the image characteristics within the range of values. Further, the camera system generates a high dynamic range image of the scene from a plurality of images of the subset of images by compositing different pixels or regions of pixels of different images to form the HDR image. The HDR image may have a much wider dynamic range relative to other approaches that merely capture several images to generate an HDR image, because the amount of images stored in the camera system database is much greater. Moreover, the large amount of images allows the user to have greater flexibility in choosing the images to generate the HDR image.

The above described camera system enables a user to “post process” the final images to his/her taste by increasing or decreasing values in the image characteristic profile. When an increase or decrease in a value is requested, the query module operates on the image database and selects the closest matching image from the plurality of images. In other words, modifying the image characteristic profile merely causes selection of a different image. This step avoids any sort of digital gain to be applied to any of the images after capture by the camera software system. Note that the database may return one or more images having image characteristic values that most closely match the image profile or a new image may be generated using pixels having image characteristic values that most closely match the image characteristic profile from different images.

It will be appreciated that in some embodiments, the image database may only store user images and analysis may be performed on only the user images as opposed to the images of the entire network of users. Such a case may occur in embodiments where the image database is situated locally in the camera system.

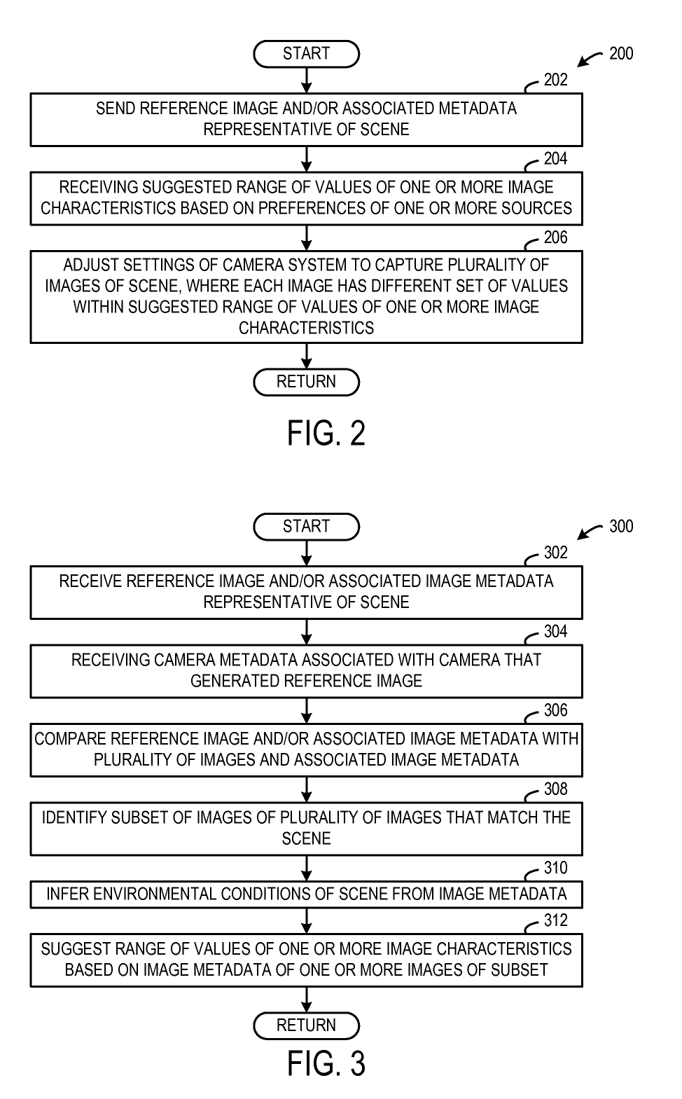

FIG. 2 shows a method 200 for controlling a camera based image characteristic feedback according to an embodiment of the present description. In one example, the method is performed by the camera system 100 shown in FIG. 1.

At 202, the method includes sending a reference image and/or associated metadata representative of a scene to an image database. In one example, the reference image and/or associated metadata is sent to a remote computing device that stores a plurality of images in the image database, such as computing device 124 shown in FIG. 1.

At 204, the method 200 includes receiving a suggested range of values of one or more image characteristics based on preferences of one or more sources. In one example, the image characteristics include an exposure setting, a focus setting, and a white balance setting, and a different range of values are suggested for each of the exposure setting, the focus setting, and the white balance setting.

The one or more sources may take various forms. In one example, the one or more sources include a plurality of images previously captured by the camera system and stored in the image database, and the suggested range of values of the one or more image characteristics are based on image characteristics of the plurality of previously captured images. In another example, the one or more sources include one or more images rated highly by a network of users, and the suggested range of values of the one or more image characteristics are based on image characteristics of the one or more highly rated images. In another example, the one or more sources include an expert photographer, and the suggested range of values of the one or more image characteristics are based on image characteristics of images captured by the expert photographer.

At 206, the method 200 includes adjusting settings of the camera system to capture a plurality of images of the scene. In particular, the settings are adjusted such that each image of the plurality of images has a different set of values within the suggested range of values of the one or more image characteristics. In one example, the plurality of images includes image characteristics that vary by a defined granular step across the suggested range of values of each image characteristic. In one example, adjusting settings includes adjusting an exposure setting, a focus setting, and a white balance setting in the camera hardware system.

FIG. 3 shows a method 300 for providing feedback to a camera for controlling camera settings to capture a plurality of images of a scene according to an embodiment of the present description. In one example, the method 300 is performed by the image database 122 and/or the computing device 124 shown in FIG. 1.

At 302, the method 300 includes receiving a reference image and/or associated image metadata representative of a scene. The reference image and/or associated image metadata may be received from a camera system.

At 304, the method 300 includes receiving camera metadata associated with the camera that generated the reference image. The camera metadata indicates camera-specific settings for manipulating image characteristics of images generated by the camera.

At 306, the method 300 includes comparing the reference image and/or associated image metadata representative of the scene with a plurality of images and associated image metadata stored in the image database. The image metadata associated with each image of the plurality of images indicates image characteristics of that image.

At 308, the method 300 includes identifying a subset of images of the plurality of images that match the scene based on the comparison. The subset of images may be identified in any suitable manner. For example, the subset of images may be identified based on one or more of a computer vision process applied to the reference image to identify the scene, a GPS position associated with the reference image, and image metadata indicating the scene, such as a landmark or other tag.

At 310, the method 300 includes inferring environmental conditions of the scene from the image metadata of the reference image.

At 312, the method 300 includes suggesting a range of values of one or more image characteristics based on image metadata of one or more images of the subset. The suggested range of values may be used to adjust settings of the camera to capture a plurality of images of the scene having different values of the one or more image characteristics within the range of values. In one example, the one or more images of the subset whose image metadata on which the suggested range of values is based are selected because the one or more images are rated highly by a network of users. In another example, the one or more images of the subset whose image metadata on which the suggested range of values is based are selected because the one or more images are associated with an expert photographer.

In some embodiments, the suggested range of values of the one or more image characteristics only include values of image characteristics capable of being achieved by the camera-specific settings. In some embodiments, the suggested range of values of the one or more image characteristics are further based on the inferred environmental conditions of the scene.

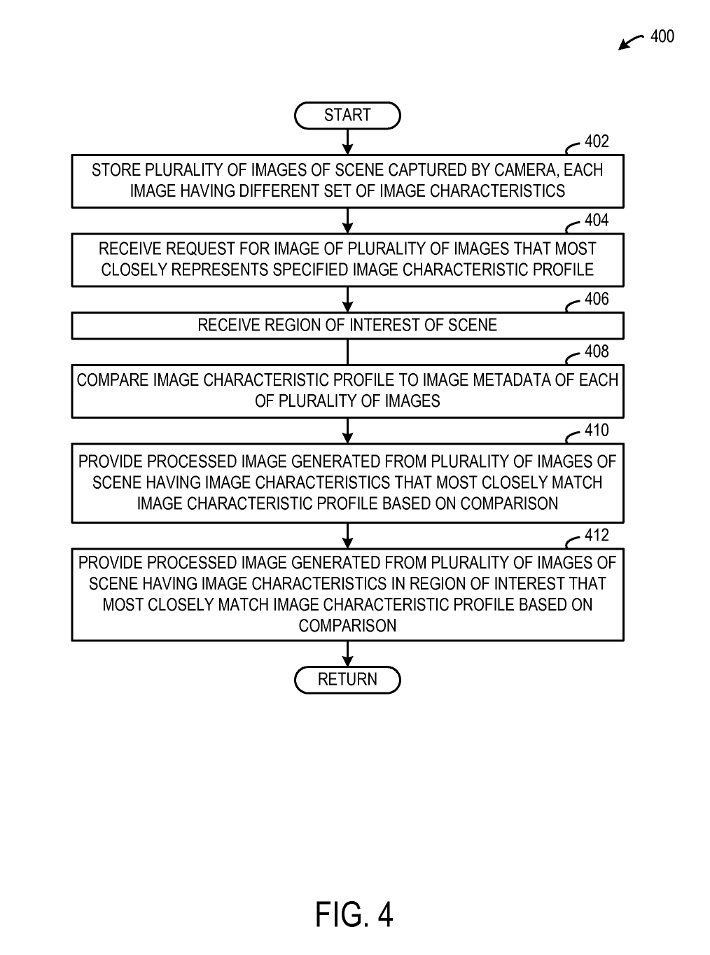

FIG. 4 shows a method 400 for selecting an image of a scene captured by a camera based on a desired image characteristic profile according to an embodiment of the present description. In one example, the method 400 is performed by the image database 122 and/or the computing device 124 shown in FIG. 1.

At 402, the method 400 includes storing a plurality of images of a scene captured by a camera and associated image metadata. In one example, the plurality of images is stored in the image database. The image metadata associated with each image of the plurality of images includes image characteristics of that image. Further, each image has a different set of values of image characteristics. In one particular example, the image characteristics include an exposure setting, a focus setting, and a white balance setting, and the image metadata associated with the plurality of images of the scene include image characteristics that vary by a defined granular step across a range of values for each of the exposure setting, the focus setting, and the white balance setting.

At 404, the method 400 includes receiving a request for an image of the plurality of images of the scene that most closely matches a specified image characteristic profile that defines one or more values of one or more image characteristics. In one example, the image characteristic profile includes a specified exposure setting value, a specified focus setting value, and a specified white balance setting value.

In one example, the image characteristic profile is provided via user input to a graphical user interface that enables user manipulation of different image characteristics of the image characteristic profile. In another example, the image characteristic profile is provided based on image characteristics of previously captured images rated highly by a user. In another example, the image characteristic profile is provided based on average preferences of image characteristics of a network of users.

In some embodiments, at 406, the method 400 includes receiving a specified region of interest of the scene. In one example, the region of interest is provided via user input to a graphical user interface that enables selection of the region of interest in a reference image of the scene.

At 408, the method 400 includes comparing the image characteristic profile to image metadata of each of the plurality of images.

At 410, the method 400 includes providing a processed image generated from the plurality of images of the scene having image characteristics that most closely match the image characteristic profile based on the comparison. In one example, providing includes selecting an image from the plurality of images of the scene as having image characteristic values that most closely match the image characteristic profile based on the comparison as the processed image. In another example, providing includes generating an image using pixels having image characteristic values that most closely match the image characteristic profile from the plurality of images of the scene. For example, the generated image may be a composite of multiple images of the plurality of images of the scene.

In embodiments of the method where a region of interest is received, at 412, the method includes providing an image selected from the plurality of images of the scene having image characteristics in the region of interest that most closely match the image characteristic profile. In one example, an image having a highest focus score and/or a highest exposure score of the region of interest is selected from the plurality of images.

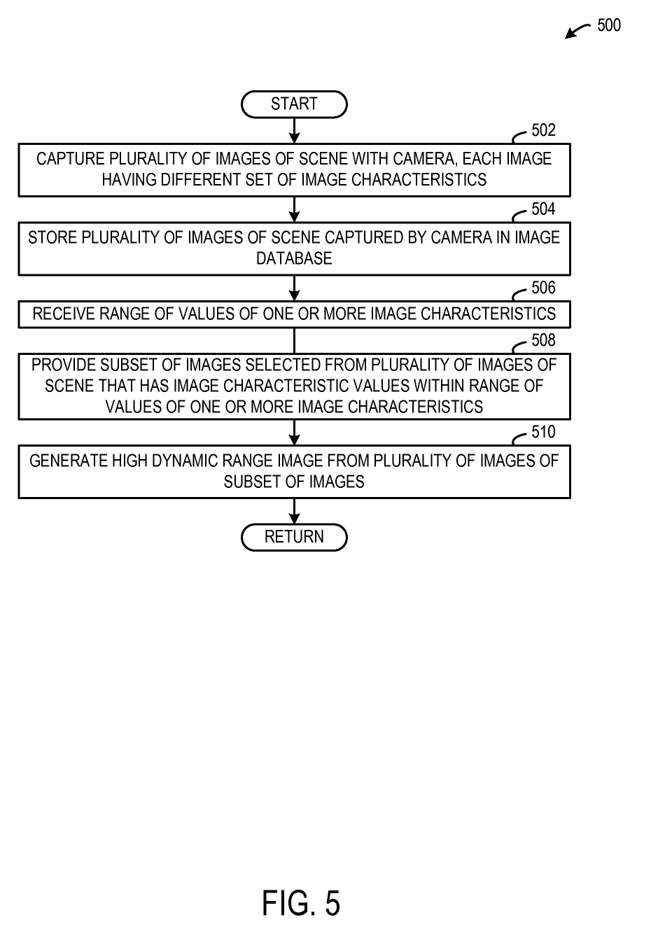

FIG. 5 shows a method 500 for providing a high dynamic range image from a plurality of images of a scene captured by a camera according to an embodiment of the present description. In one example, the method 500 is performed by the camera system 100 shown in FIG. 1. In another example, the method 500 is performed by the image database 122 and/or the remote computing system 124 shown in FIG. 1.

At 502, the method includes capturing a plurality of images of a scene. Each image of the plurality of images has a different set of image characteristic values.

At 504, the method includes storing the plurality of images of the scene in an image database.

At 506, the method 500 includes receiving a range of values of one or more image characteristics. In one example, the range of values of image characteristics includes a range of values of an exposure setting, a range of values of a focus setting, and a range of values of a white balance setting. In one example, the range of values of image characteristics is provided via user input to a graphical user interface that enables user manipulation of different image characteristics.

At 508, the method 500 includes providing a subset of images of the scene selected from the plurality of image of the scene captured by the camera. Each image of the subset of images of the scene has a value of the one or more image characteristics within the range of values.

At 510, the method 500 includes generating a high dynamic range image of the scene from a plurality of images of the subset of images.

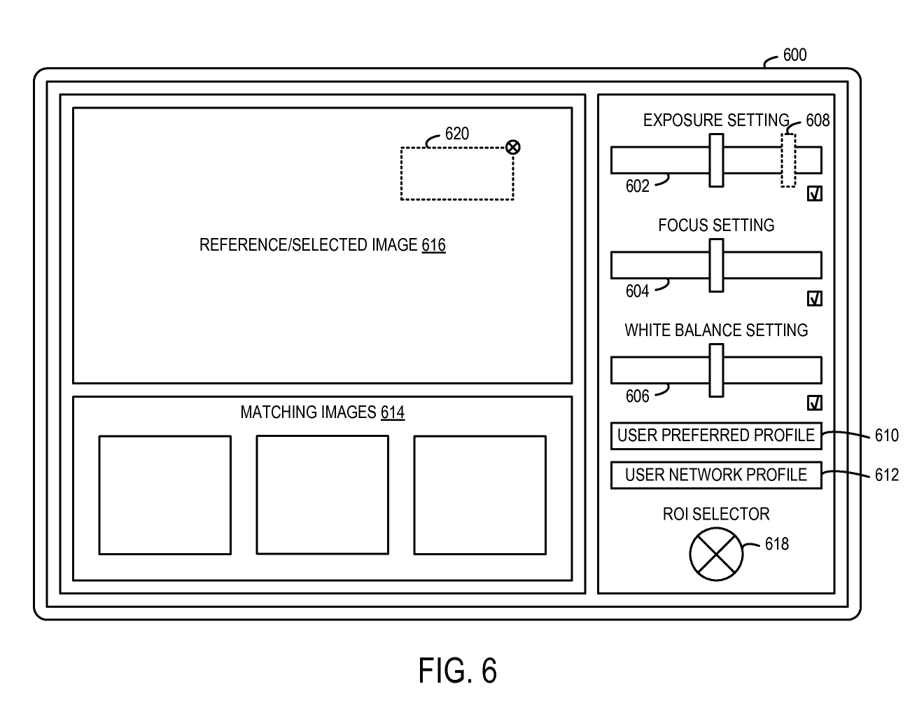

FIG. 6 shows a graphical user interface (GUI) 600 according to an embodiment of the present description. In one example, the GUI is presented by the camera system. Although in some embodiments, the GUI may be presented by another computing device associated with a user of the camera system. The GUI enables a user to provide user input that enables user manipulation of different image characteristics of the image characteristic profile. In particular, the GUI includes manual inputs including an exposure setting input 602, a focus setting input 604, and a white balance setting input 606. Each setting includes a range of possible values and a slider that selects a value from the range of possible values. The user adjusts the position of the slider to select a desired value for the image characteristic profile.

In some embodiments, the manual inputs may include a second slider 608 that defines an upper end of selected range of values of the image characteristic. Further, the other slider defines the lower end of the selected range of values that is smaller than the possible range of values. Each image characteristic setting may be capable of selecting a user defined range of values. In some embodiments, one or more of the image characteristic setting inputs may be enabled/disabled by checking the associated box. If the box is checked, then the image characteristic is considered in the image characteristic profile.

The GUI further includes automatic inputs including a user preferred profile 610 and a user network preferred profile. The automatic inputs may be selected instead of manually setting the values of the image characteristic profile via the manual inputs. The user preferred profile is an image characteristic profile where values of image characteristics are determined based on user preferences. In one example, the image characteristic values are based on image characteristics of images previously captured by the user. In another example, the image characteristic values are based on image characteristics of images rated highly by the user.

The user network profile is an image characteristic profile where values of image characteristics are determined based on preferences of a network of users. In one example, the image characteristic values are based on image characteristics of images captured by an expert photographer of the user network. In another example, the image characteristic values are based on image characteristics of images rated highly by user of the user network.

The manual and automatic inputs may be used to tune the values of the image characteristic profile that determines which image(s) are returned by the image database. The matching images 614 are displayed in the matching images pane of the GUI. As the user changes the image characteristic profile, the matching images may be updated to correspond to the changes. In other words, when an increase or decrease in image characteristic value is requested, the camera software system operates on the database and tries to select closest matching images from the image stored in the database. An image 616 selected from the matching images may be displayed in a larger pane of the GUI in greater detail. Alternatively, or additionally a processed image that is a composite of pixels from the images returned from the image database having image characteristic values that most closely match the image characteristic profile is displayed in the larger pane.

The GUI includes a region of interest selector 618 that enables a region of interest 620 of scene to be selected. In particular, when the region of interest selector is enabled a reference image of the scene is displayed in the large pane of the GUI, and the region of interest may be defined by the user on the reference image. In one example, when the region of interest selector is pressed, the user is allowed to tap in the image viewing area to create a region of interest at the tap point. In response to creation of the region of interest, the image database is queried to compare the image characteristic values of the region of interest of the plurality of images of the scene with the image characteristic profile, and select images that most closely match.

It will be understood that methods described herein are provided for illustrative purposes only and are not intended to be limiting. Accordingly, it will be appreciated that in some embodiments the methods described herein may include additional or alternative steps or processes, while in some embodiments, the methods described herein may include some steps or processes that may be reordered, performed in parallel or omitted without departing from the scope of the present disclosure. Moreover, two or more of the methods described herein may be at least partially combined.

It will be understood that the concepts discussed herein may be broadly applicable to capturing a large variety of images of a scene having different sets of image characteristics in order to provide an image that meets a desired image characteristic profile while avoiding post processing. Furthermore, it will be understood that the methods described herein may be performed using any suitable software and hardware in addition to or instead of the specific examples described herein. The subject matter of the present disclosure includes all novel and non-obvious combinations and sub-combinations of the various processes, systems and configurations, and other features, functions, acts, and/or properties disclosed herein, as well as any and all equivalents thereof. It will be understood that the configurations and/or approaches described herein are exemplary in nature, and that these specific embodiments or examples are not to be considered in a limiting sense, because numerous variations are possible.

1. A method for generating an image of a scene captured by a camera, the method comprising:
storing a plurality of images of the scene captured by the camera and associated image metadata, where image metadata associated with each image of the plurality of images includes image characteristics of that image, and where each image has a different set of values of image characteristics;
receiving a request for an image that most closely matches a specified image characteristic profile that defines one or more values of one or more image characteristics;
comparing the image characteristic profile to image metadata of each of the plurality of images; and
providing a processed image generated from the plurality of images of the scene having image characteristic values that most closely match the image characteristic profile based on the comparison.

2. The method of claim 1, where the image characteristics include an exposure setting, a focus setting, and a white balance setting, and where image metadata associated with the plurality of images of the scene include image characteristic values that vary by a defined granular step across a range of values for each of the exposure setting, the focus setting, and the white balance setting.

3. The method of claim 1, where the image characteristic profile includes a specified exposure setting value, a specified focus setting value, and a specified white balance setting value.

4. The method of claim 1, further comprising:
receiving a specified region of interest of the scene; and
providing a processed image generated from the plurality of images of the scene that has a highest focus score and/or a highest exposure score of the region of interest.

5. The method of claim 1, where the image characteristic profile is one or more of provided via user input to a graphical user interface that enables user manipulation of different image characteristics of the image characteristic profile, provided based on image characteristics of previously captured images rated highly by a user, and provided based on average preferences of image characteristics of a network of users.

6. The method of claim 1, where the processed image is selected from the plurality of images of the scene as having image characteristic values that most closely match the image characteristic profile based on the comparison.

7. The method of claim 1, where the processed image is composited from pixels having image characteristic values that most closely match the image characteristic profile of the plurality of images of the scene based on the comparison.

8. A camera system comprising:
a camera hardware system;
a processor; and
a storage device holding instructions that when executed by the processor:
adjust settings of the camera hardware system to capture a plurality of images of a scene, where image metadata associated with each image of the plurality of images includes image characteristics of that image, and where each image has a different set of values of image characteristics;
receive a request for an image of the plurality of images of the scene that most closely matches a specified image characteristic profile that defines one or more values of one or more image characteristics; and
provide a processed image generated from the plurality of images of the scene having image characteristics that most closely match the image characteristic profile based on a comparison of the image characteristic profile with the image metadata of each of the plurality of images.

9. The camera system of claim 8, further comprising:
an image database, and where the storage device holds instructions that when executed by the processor: store the plurality of images of the scene and associated image metadata in the database, and where the processed image is provided responsive to a query of the database that includes the image characteristic profile.

10. The camera system of claim 8, where the storage device holds instructions that when executed by the processor:
send the plurality of images of the scene and associated image metadata to a remote computing device for storage in a database;
send a query including the image characteristic profile to the remote computing device; and
receive the processed image from the remote computing device, where the processed image is provided responsive to the query.

11. The camera system of claim 8, where the storage device holds instructions that when executed by the processor:
receive a specified region of interest of the scene; and
provide a processed image generated from the plurality of images of the scene that has a highest focus score and/or a highest exposure score of the region of interest.

12. The camera system of claim 8, where the image characteristic profile is provided via user input to a graphical user interface that enables user manipulation of different image characteristics of the image characteristic profile.

13. The camera system of claim 8, where the image characteristic profile is provided based on image characteristics of previously captured images rated highly by a user.

14. The camera system of claim 8, where the image characteristic profile is provided based on average preferences of image characteristics of a network of users.

15. The camera system of claim 8, where the image characteristics include an exposure setting, a focus setting, and a white balance setting, where image metadata associated with the plurality of images of the scene include image characteristic values that vary by a defined granular step across a range of values for each of the exposure setting, the focus setting, and the white balance setting, and where the image characteristic profile includes a specified exposure setting value, a specified focus setting value, and a specified white balance setting value.

16. The computing system of claim 8, where the storage device further includes instruction that when executed by the processor:
send a reference image and/or associated image metadata representative of a scene to a database that stores a plurality of images;
receive a suggested range of values of one or more image characteristics from the database, where the suggested range of values of the one or more image characteristics are based on image characteristics of one or more images of a subset of the plurality of images that match the scene of the reference image; and where each image of the plurality of images of the scene captured by the camera has a different set of values within the suggested range of values of the one or more image characteristics.

17. The computing system of claim 8, where the camera hardware system includes a camera array that captures the plurality of images of the scene.

18. A method for generating a high dynamic range image from a plurality of images captured by a camera, the method comprising:
receiving a range of values of one or more image characteristics;
providing a subset of images of a scene selected from a plurality of image of the scene captured by the camera, where each image of the plurality of images of the scene has a different set of values of image characteristics, and where each image of the subset of images of the scene has a value of the one or more image characteristics within the range of values; and
generating a high dynamic range image of the scene from a plurality of images of the subset of images.

19. The method of claim 18, where the range of values of image characteristics is provided via user input to a graphical user interface that enables user manipulation of different image characteristics.

20. The method of claim 18, where the range of values of image characteristics includes a range of values of an exposure setting, a range of values of a focus setting, and a range of values of a white balance setting.
